(19) United States
(12) Patent Application Publication
(10) Pub. No.: US 2024/0335983 A1
(43) Pub. Date: Oct. 10, 2024

(54) COLLAPSING CORE MOULD

(71) Applicant: StackTeck Systems Limited, Brampton (CA)

(72) Inventors: Kevin Khai-Hai CHIU, Markham (CA); Ealias C. JOSEPH, Markham (CA)

(21) Appl. No.: 18/131,070

(22) Filed: Apr. 5, 2023

(51) Int. Cl. B29C 33/48; B29C 37/00

(52) U.S. Cl. CPC B29C 33/485; B29C 37/0017

(57) ABSTRACT

A collapsing core mould is provided for forming a moulded part. The collapsing core mould has a longitudinally moveable center section for withdrawing from a plurality of surrounding laterally moveable peripheral sections, at least some of which laterally moveable peripheral sections are also longitudinally moveable. Withdrawal of the center section allows lateral movement of the at least some of the peripheral sections toward each other. Subsequent longitudinal withdrawal of the at least some of the peripheral sections allows for the remaining peripheral sections to move toward each other and release the moulded part.

### FIELD

The present invention relates generally to moulds, specifically, collapsing core moulds for forming a moulded part.

### BACKGROUND

Conventional collapsing core moulds are typically used for plastic injection moulding and extrusion to create moulded parts. These moulded parts can include containers or closures. As the moulds are collapsible, moulded parts such as closures with smaller neck diameters than the core or body can be formed by releasing the internal undercut or smaller neck. These containers can be caps for containers where the caps have a smaller neck diameter than the body, or cosmetic jars where the jars have a smaller neck diameter than the body.

Some collapsing core technologies are radially symmetrical and involve some interlocking of the collapsing components to guide the motion of collapsing relative to each other to allow for simultaneous collapsing of components. Earlier collapsing core technologies of the applicant typically involve an angled core 202 with peripheral components 204 that all collapse simultaneously as shown in FIGS. 1A through 1C labeled as PRIOR ART As can be seen, the collapsing, and subsequent undercuts achieved, are limited by the greater sloping 209 required on the components for simultaneous collapsing. The peripheral components may be formed by lower splits 207 and upper splits 211. The lower splits 207 may be connected to lower bars 207a that interact with lower cams 207b that move the lower splits 207 toward each other (inward) as the lower bars 207a move forward. The upper splits 211 may be attached to upper bars 211a that interact with upper cam 211b.

In FIGS. 1A through 1C, an exemplary conventional collapsing core technology is shown. As the angled core 202 withdraws, the peripheral components 204 simultaneously collapse, permitting the removal of the formed moulded part.

It is an object of the present design to provide a collapsing core mould for forming a moulded part without interlocking components.

### SUMMARY

According to an aspect of the present invention there is provided a collapsing core mould for forming a moulded part. The collapsing core mould comprises a center section and a plurality of peripheral sections having a base portion opposing a top portion. The plurality of peripheral sections surround the center section. The center section is longitudinally moveable to withdraw from between the peripheral sections. The peripheral sections are laterally moveable to allow the peripheral sections to move toward each other. At least some of the peripheral sections are further longitudinally moveable to withdraw from the remaining peripheral sections. As well, the longitudinal withdrawal of the center section and subsequently longitudinal withdrawal of the at least some of the peripheral sections enables lateral movement of the remaining peripheral sections toward each other to allow removal of the moulded part.

### BRIEF DESCRIPTION OF THE DRAWINGS

These and other features of the invention will become more apparent from the following description in which reference is made to the appended drawings wherein:

FIG. 1A is a perspective view of a prior art collapsible core mould;

FIG. 1B is a longitudinal cross section on line 1B-1B of FIG. 1A;

FIG. 1C is a perspective view of the prior art collapsible core mould of FIG. 1A shown in an assembled position;

FIG. 2A is a perspective view of a collapsible core mould part inserted into a cavity part ready for moulding in accordance with one embodiment of the present invention;

FIG. 2B is a longitudinal cross-section on line 2B-2B of FIG. 2A;

FIG. 2C is a longitudinal cross-section on line 2C-2C of FIG. 2A;

FIG. 3A is a perspective view of a collapsible core mould of FIG. 2A before ejection begins in accordance with one embodiment of the present invention;

FIG. 3B is a longitudinal cross-section on line 3B-3B of FIG. 3A;

FIG. 4A is a perspective view of the collapsible core mould of FIG. 2A showing the longitudinal withdrawal of the center section from the peripheral sections comprised of the front and rear sections and first and second side sections;

FIG. 4B is a longitudinal cross-section on line 4B-4B of FIG. 4A;

FIG. 4C is a perspective view of the collapsible core mould of FIG. 4A in an assembled position;

FIG. 5A is a perspective view of the collapsible core mould of FIG. 2A showing the subsequent longitudinal withdrawal of the front and rear sections (lower core splits);

FIG. 5B is a longitudinal cross-section on line 5B-5B of FIG. 5A;

FIG. 6A is a perspective view of the collapsible core mould of FIG. 2A showing the lateral movement of the first and second side sections (upper core splits) toward each other;

FIG. 6B is a longitudinal cross-section on line 6B-6B of FIG. 6A;

FIG. 6C is a perspective view of the collapsible core mould of FIG. 6A in an assembled position;

FIG. 7A is a perspective view of a ring-shaped exemplary moulded part;

FIG. 7B is an alternate perspective view of the moulded part of FIG. 7A;

FIG. 7C is a cross sectional view on line 7C-7C of the moulded part of FIG. 7A;

FIG. 8A is a perspective view of an exemplary moulded part having an external ledge;

FIG. 8B is an alternate perspective view of the moulded part of FIG. 8A;

FIG. 8C is a cross-sectional view on line 8C-8C of the moulded part of FIG. 8A;

FIG. 9A is a perspective view of an exemplary moulded part having a smooth cylindrical interior and external profile;

FIG. 9B is an alternate perspective view of the moulded part of FIG. 9A;

FIG. 9C is a cross-sectional view on line 9C-9C of the moulded part of FIG. 9A;

FIG. 10A is a perspective view of an exemplary moulded part having a ridged cylindrical interior and external profile;

FIG. 10B is an alternate perspective view of the moulded part of FIG. 10A;

FIG. 10C is a cross-sectional view on line 10C-10C of the moulded part of FIG. 10A;

FIG. 11A is a perspective view of an exemplary moulded part having a tapered interior and external profile;

FIG. 11B is an alternate perspective view of the moulded part of FIG. 11A; and

FIG. 11C is a cross-sectional view on line 11C-11C of the moulded part of FIG. 11A;

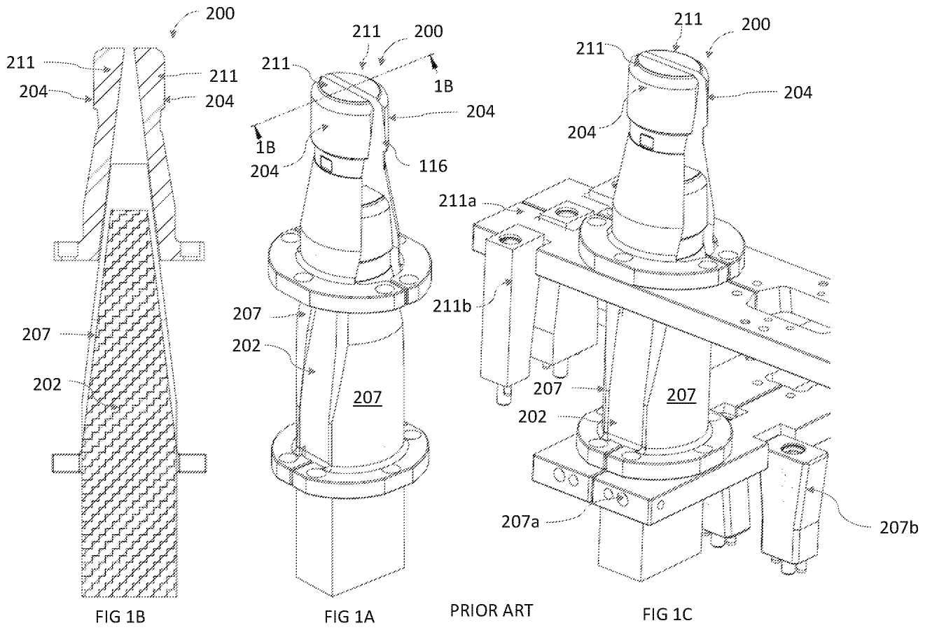

### DETAILED DESCRIPTION

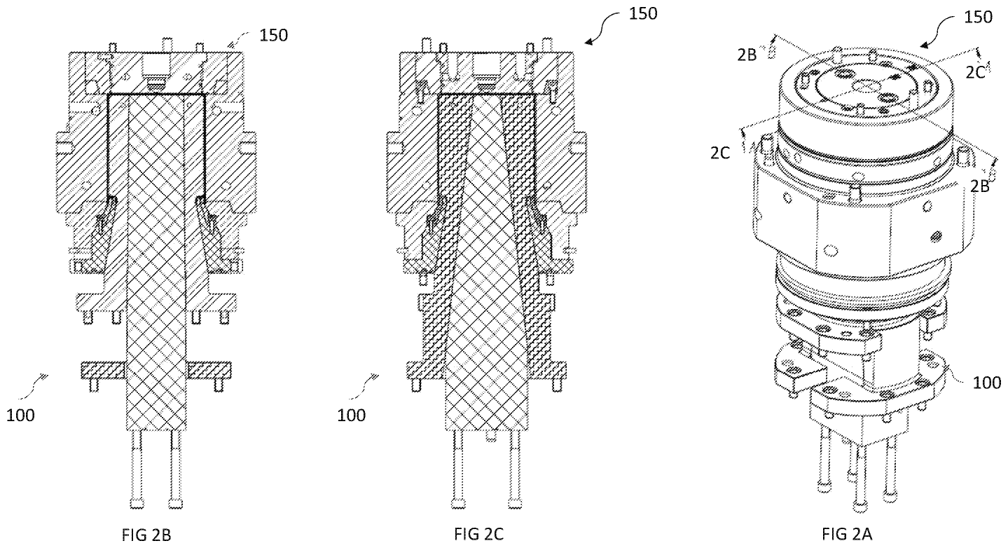

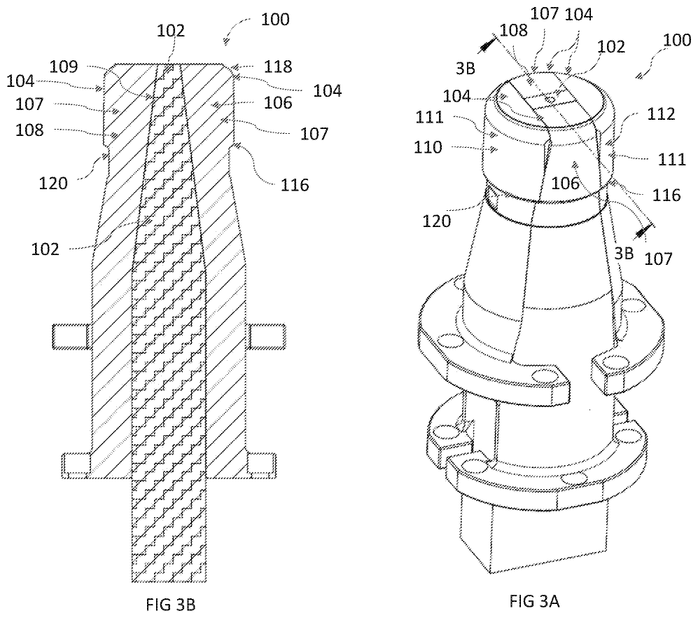

Reference is now made to FIGS. 2A through 6C, in which one illustrative embodiment of a collapsing core mould is indicated generally at reference 100. FIGS. 2A-2C show a collapsing core mould 100 inserted into a cavity part 150 ready for moulding. According to an aspect of the present invention, there is provided a collapsing core mould 100 for forming a moulded part referenced generally as numeral 10. The collapsing core mould 100 has a center section or center wedge 102 and a plurality of peripheral sections generally shown by reference 104. In this embodiment, as can be seen in FIGS. 2A and 2B, the peripheral sections 104 further comprise lower core splits 107 defined by a front section 106 opposite a rear section 108 with the center section 102 disposed therebetween. The peripheral sections 104 further comprise upper core splits 111 defined by a first side section 110 opposite a second side section 112 with the center section 102 disposed therebetween.

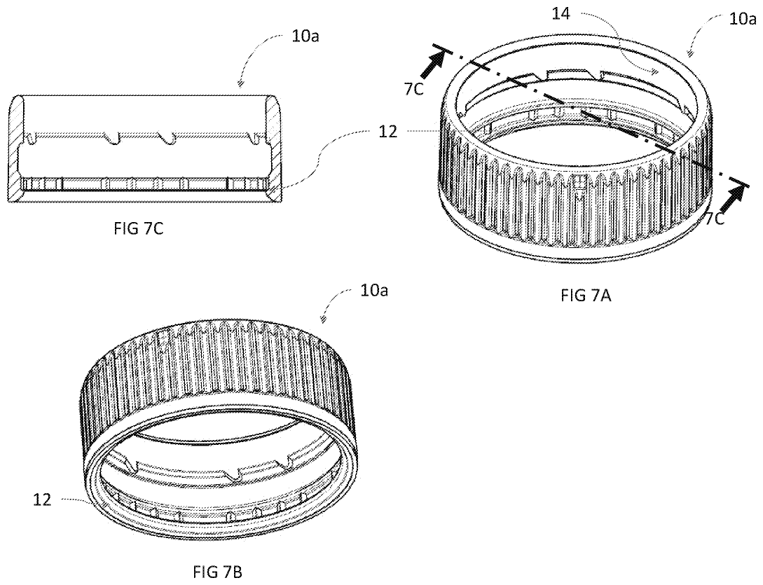

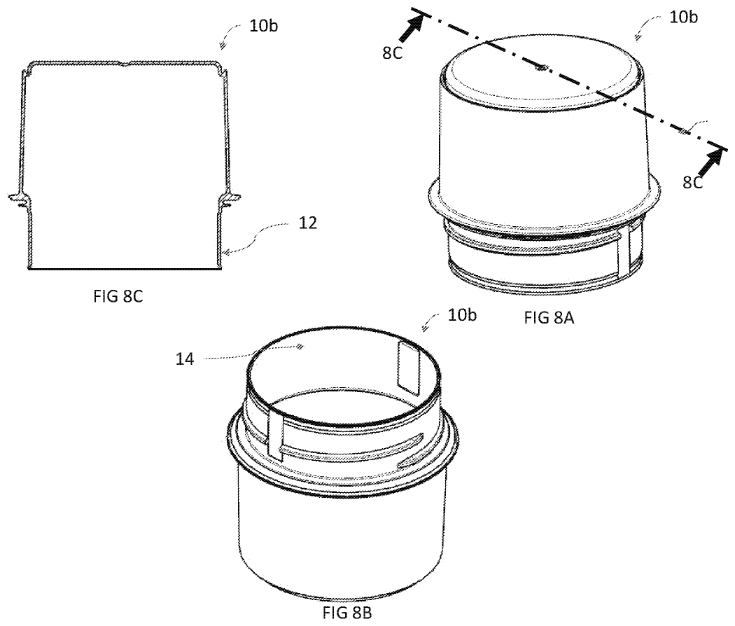

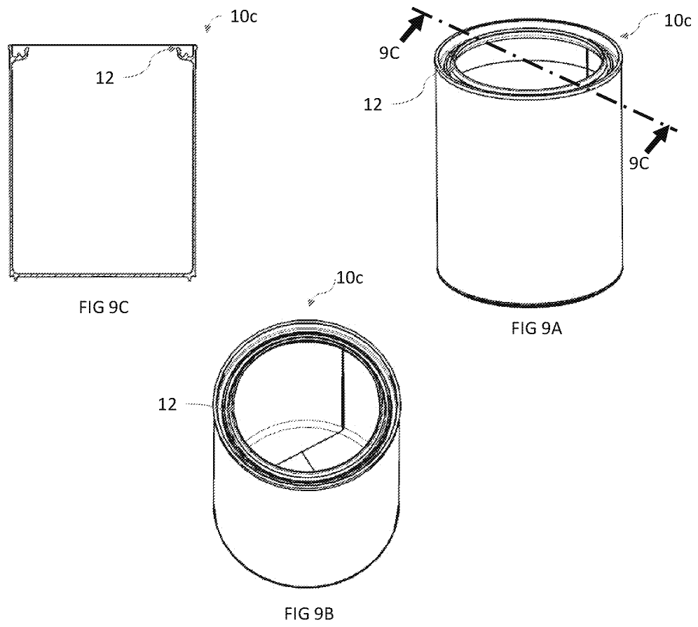

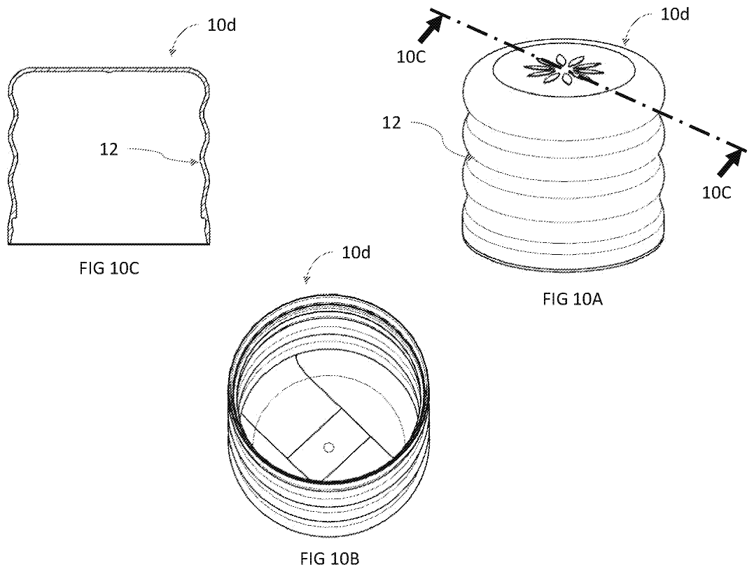

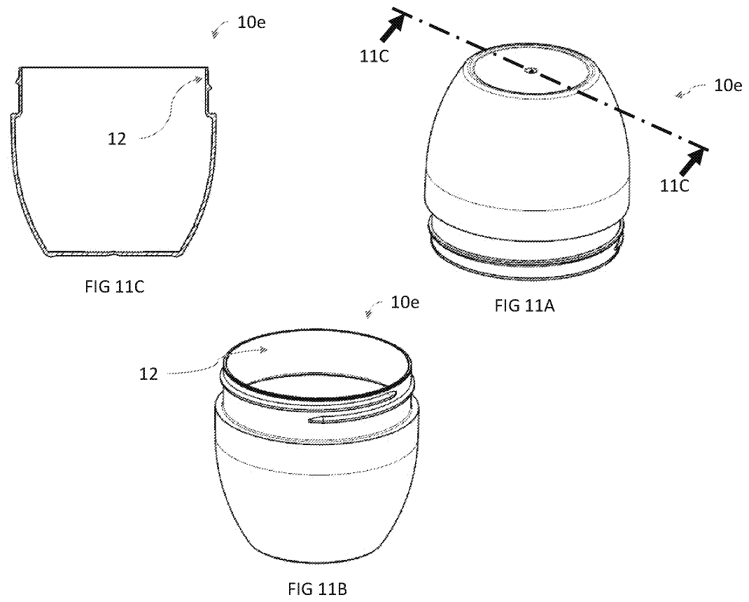

In this embodiment, the lower core splits 107 and upper core splits 111 defining the front, rear, first side and second side sections, 106 to 112 forming the peripheral sections 104 fully encase the center section 102. When assembled, the external profile of these peripheral sections forms the internal profile of the moulded part. Therefore, a generally cylindrical external profile 114 as shown yields a generally cylindrical internal profile 14 for the moulded part such as a jar or closure cap. As shown in the exemplary figures, the external profile could be ring like, tapered, or ovoid, oblong or another suitable profile to create a moulded part with the desired corresponding internal profile (not shown). Similarly, it may have a smooth or ridged or other internal profile as shown, for example, in FIGS. 7A-11C.

The peripheral sections 104 have a base portion 116 opposing a top portion 118. In this embodiment, the base portion 116 of the peripheral sections 104 is defined by an indentation 120 corresponding to an inwardly extending ledge 12 of the moulded part. The inwardly extending ledge 12 of the moulded part could form the undercut or smaller neck of the moulded part. If the indentation 120 is angled, the neck of the moulded part is correspondingly angled. Similarly, other profiles are also contemplated as shown in FIGS. 7A-11C.

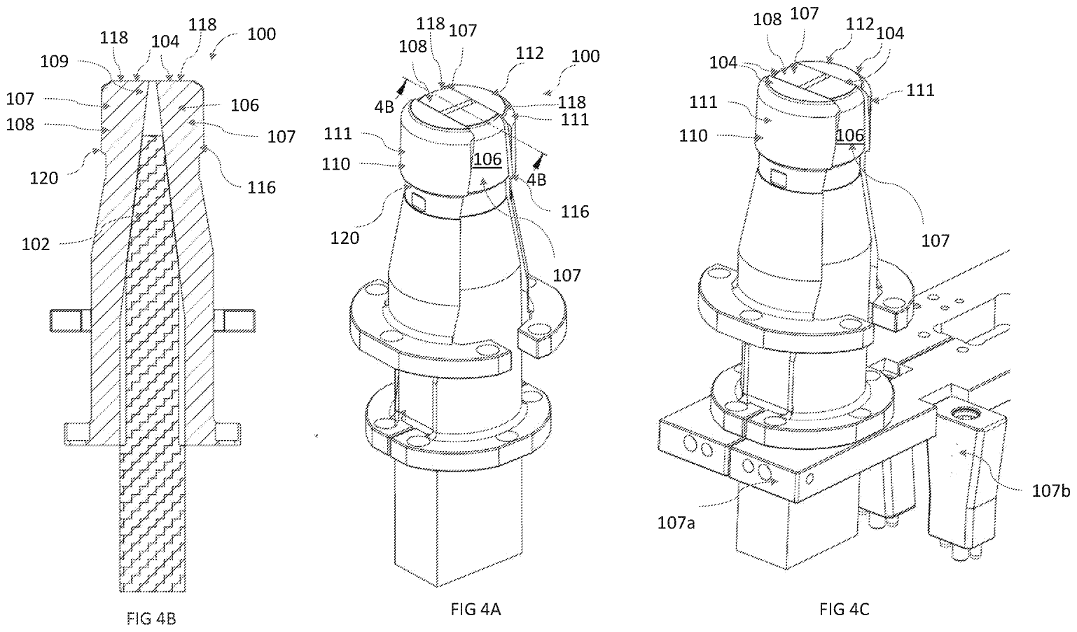

Referring now to FIGS. 4A and 4C, the center section is a center wedge 102 that is longitudinally moveable to withdraw from between the peripheral sections 104. This withdrawal of the center section or center wedge 102 and the simultaneous collapse of the lower core splits 107 forms the first movement. In this embodiment, the center section 102 has a generally tapered profile forming a center wedge. The center wedge is tapered with respect to the lower core splits 107, but, as shown in FIGS. 5A and 5B, the lower core splits 107 are only marginally tapered, approximately 0.5 degrees with respect to the upper core splits 111. This shallower sloping allows for a greater collapsing benefit achieving greater undercuts.

Thus, in the first movement, the lower core splits 107 collapse which are mounted to lower carrier bars 107a. These lower carrier bars 107a interact with lower cams 107b that move the lower core splits toward each other (inward) as the lower carrier bars 107a move forward. This first simultaneous movement, then, is cam movement.

The longitudinal withdrawal of the center section 102 enables the simultaneous collapse or lateral movement of the front and rear sections, 106, 108 (the lower core splits 107) toward each other. Each of the front and rear sections, 106, 108 has an angled interior face 109 to abut at least a portion of the tapered profile of the center section 102. Thus, upon the withdrawal of the center section 102, the front and rear sections 106, 108 with their angled interior faces 109 can laterally move toward each other. This longitudinal withdrawal of the center section 102 may be accomplished by a forward movement of the upper and lower splits 111 and 107. In this first movement defined by the collapse of the lower core splits 107, the upper and lower core splits 111 and 107 attached to upper core plates and lower core plates (not shown) and further mounted to the upper and lower carrier bars 107a, 111a, move forward together, creating a separation between the center wedge 102 and the upper and lower core splits 111, 107. This may be actuated, for example, by machine knock-outs. Other actuation methods will be known to one with skill in the art.

Due to the slightly angled interior faces 109, the top portions 118 of the front and rear sections (lower core splits 107) can come together while the base portions 116 continue to be spaced apart, providing for some clearance between components during longitudinal withdrawal. The angle of the lower cam 107b may be slightly more than the angle between the lower core split 107 and center wedge 102. This angle differential limits the contact between components as the upper core splits 111 collapse, providing the clearance between components during longitudinal withdrawal.

In another embodiment (not shown), the lateral movement of the front and rear sections 106, 108 may be subsequent relative to the longitudinal withdrawal of the center section 102. Thus, rather than simultaneous lateral movement of the front and rear sections with the longitudinal withdrawal of the center section, the front and rear sections 106, 108 (lower core splits 107) may withdraw in a stepwise manner, subsequent to the longitudinal withdrawal of the center section 102. This stepwise movement can be accomplished by removing the angled interior face (previously shown as 109) and the tapering of the center section (previously shown as 102). Without such tapering and angled faces, the collapsing movements can be stepwise rather than simultaneous.

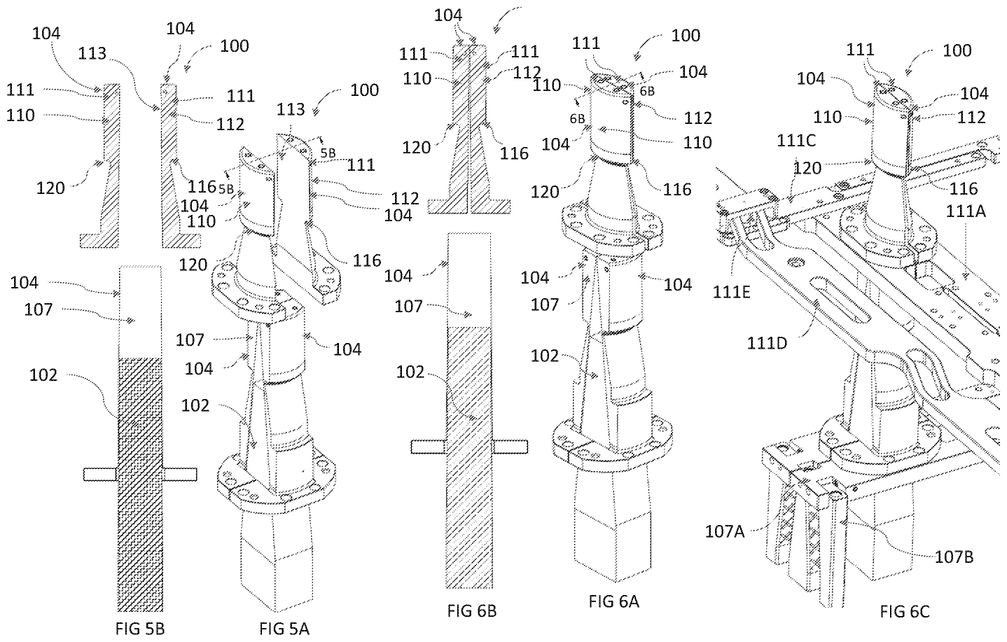

Reference is now made to FIGS. 5A through 6C. At least some of the peripheral sections are also longitudinally moveable to withdraw from the remaining peripheral sections. In this embodiment, subsequent to the withdrawal of the center section 102 and the lower core splits 107 (front and rear sections 106, 108), the upper core splits 111 (first and second side sections 110, 112) also withdraw from the remaining peripheral sections 104. Again, the longitudinal withdrawal here may be accomplished by a forward motion of the upper and lower core splits 111, 107. This could be accomplished in distinct second and third movements as described in greater detail below.

As can be seen in FIGS. 6A-6C, the longitudinal withdrawal of the front and rear sections 106, 108 (lower core splits 107) enables the lateral movement of the remaining peripheral sections, in this case the first and second side sections 110, 112 forming the upper core splits 111. The first side section 110 and the second side section 112 each has a flat interior face 113. While these flat interior faces 113 can make contact when the first side section 110 and the second side section 112 laterally move toward each other, it is not necessary for the flat interior faces 113 to make contact. It is possible that the first side section 110 and the second side section 112 come together sufficiently to release the moulded part without necessarily making contact with the other to limit the risk of damage or wear.

Importantly, here as above, the lateral movement of the first and second side sections 110, 112 is not a result of being guided due to interlocking components. Rather, the lateral movement of these first and second side sections 110, 112 (upper core splits 111) is independent of the longitudinal withdrawal of front and rear sections 106, 108 (lower core splits). Here, this second subsequent movement of the upper core splits 111 can be accomplished by the use of an upper core plate (not shown) that is mounted to an upper carrier bar 111a to which the upper core splits 111 are attached. While in the first simultaneous movement, the upper core plate and lower core plate move forward together (creating a separation between the core splits and center wedge 102), in the second movement shown more clearly in FIGS. 5A and 5B, the upper core plate continues to move forward allowing the upper core splits 111 to be completely clear of the lower core splits 107 and center wedge 102.

In contrast to the conventional core design of simultaneous collapsing, the upper core splits 111 collapse in a distinct subsequent movement shown more clearly in FIGS. 5A and 5B. The low angle on the upper core splits 111 (described above) functions to separate these movements into distinct subsequent movements as the low angle limits the ability to have simultaneous collapsing of all components. This movement can be accomplished as shown. For example, the upper core splits 111 are mounted to upper carrier bars 111a that are connected to upper push bars 111b. These upper push bars 111b are connected to the upper cam track 111c via upper cam rollers 111d. Thus, the movement of the upper cam track 111c moves each connected component, thereby causing the collapsing of the upper core splits 111. The upper cam track 111c may be actuated by a hydraulic cylinder but other available means of movement may also be known to one skilled in the art.

Upon the inwardly lateral movement of the remaining peripheral sections, the moulded part is capable of being released. Thus, the moulded part, initially surrounds the mould formed of the plurality of peripheral sections. Upon the withdrawal of the peripheral sections, in this case the front and rear sections 106, 108, the moulded part is held exclusively by the remaining peripheral sections, in this case the first side section 110 and the second side section 112. Upon the inward lateral movement of the first side section 110 and the second side section 112, the moulded part continues to be held by the remaining peripheral section but is no longer secured by the same. Specifically, the moulded part is held by the top portion 118 of the first and second side sections 110, 112 but is no longer held by the base portion of the first and second side sections 110, 112. Rather, what remains upon the inward lateral movement of the remaining peripheral parts at the location of the indentation 120 is the inwardly extending ledge of the moulded part. The moulded part may then be retrieved. Alternatively, the moulded part may be ejected using, pneumatic or hydraulic cylinders to eject the moulded part either directly or through forward movement of an intermediary such as a stripper ring as will be known to one with skill in the art.

Although the specific embodiment above is defined by the peripheral sections comprising a front section 106, rear section 108, first side section 110, and second side section 112, the actual number of peripheral sections may vary. For example, rather than having four peripheral sections, the collapsing core mould could have six, eight or more peripheral sections, generally in pairs.

One or more currently preferred embodiments have been described by way of example. It will be apparent to persons skilled in the art that a number of variations and modifications can be made without departing from the scope of the invention as defined in the claims.

### PARTS LIST

10 moulded part
12 inwardly extending ledge profile
14 circular cylindrical profile
100 collapsing core mould
102 center section
104 peripheral sections
106 front section mold
107 lower core splits
107a lower carrier bars components
107b lower cam
108 rear section
109 angled interior face
110 first side section
111 upper core splits
211a upper bars
111a upper carrier bars
111b upper push bars
111c upper cam track
111d upper cam rollers
112 second side section
113 flat interior face
114 cylindrical external
116 base portion
118 top portion
120 indentation
150 cavity part
200 prior art collapsing
202 angled core
204 peripheral
207 lower splits
207a lower bars
207b lower cams
209 sloping
211 upper splits
211b upper cam

What is claimed is:

1. A collapsing core mould for forming a moulded part, said core mould comprising:
a center section;
a plurality of peripheral sections having a base portion opposing a top portion, said plurality of peripheral sections surrounding said center section;
said center section being longitudinally moveable to withdraw from between said peripheral sections;
said peripheral sections being laterally moveable to allow said peripheral sections to move toward each other;
at least some of the peripheral sections further being longitudinally moveable to withdraw from the remaining peripheral sections;
the longitudinal withdrawal of said center section enabling lateral movement of at least some of the peripheral sections toward each other; and
the longitudinal withdrawal of said at least some of the peripheral sections enabling a distinct subsequent lateral movement of the remaining peripheral sections toward each other to allow removal of the moulded part.

2. The collapsing core mould of claim 1, wherein said center section has a generally tapered profile.

3. The collapsing core mould of claim 2, said peripheral sections further comprising:
a front section opposite a rear section with said center section disposed therebetween; and
a first side section opposite a second side section with said center section disposed therebetween;

4. The collapsing core mould of claim 3, wherein said front section and said rear section are each longitudinally moveable, and wherein the first side section and the second side section form the remaining peripheral sections.

5. The collapsing core mould of claim 3, wherein the longitudinal withdrawal of the center section allows the front section and the rear section to move toward each other.

6. The collapsing core mould of claim 4, wherein said front section and said rear section each has an angled interior face to abut at least a portion of the tapered profile of the center section.

7. The collapsing core mould of claim 4, wherein said first side section and said second side section each has a flat interior face to allow the flat interior face of the first section to contact the flat interior face of the second side section.

8. The collapsing core mould of claim 1, wherein said peripheral sections together form a generally cylindrical external profile to form a molded part having a corresponding cylindrical internal profile.

9. The collapsing core mould of claim 7, wherein said base portion of said peripheral sections is defined by an indentation corresponding to an inwardly extending ledge of the moulded part.

10. The collapsing core mould of claim 1, wherein said center section and peripheral sections do not have components which interlock with each other.

11. The collapsing core mould of claim 1 being insertable into a cavity part for forming the moulded part.

12. A method of stripping a moulded part from the collapsing core mould of claim 1, the method comprising:
longitudinally withdrawing said center section from between said peripheral sections;
laterally moving some of the peripheral sections toward each other;
longitudinally withdrawing said some of the peripheral sections from the remaining peripheral sections; and
laterally moving the remaining peripheral sections toward each other to allow removal of the moulded part.

13. The method of claim 1, further comprising ejecting the moulded part from said remaining peripheral sections.

14. The method of claim 1, wherein the longitudinal withdrawal of said center section and lateral movement of some of the peripheral sections toward each other occurs simultaneously.
